(19) United States
(12) Patent Application Publication
(10) Pub. No.: US 2012/0250355 A1
(43) Pub. Date: Oct. 4, 2012

(54) DISPLAY DEVICE

(75) Inventor: Takeaki HIRASAWA, Tokyo (JP)

(73) Assignee: Sony Corporation, Tokyo (JP)

(21) Appl. No.: 13/417,718

(22) Filed: Mar. 12, 2012

(30) Foreign Application Priority Data
Mar. 30, 2011 (JP) 2011-076569

(51) Int. Cl. F21V 29/00; F21V 8/00

(52) U.S. Cl. 362/613

(57) ABSTRACT

A display device includes a housing constituted by at least one chassis, a display disposed inside the housing, a light guide plate disposed in the back side face of the display and of which at least one portion of the outer circumference face is formed as an incident face to which light is incident, a light source unit having light sources that are disposed in the sides of the light guide plate so as to face the incident face of the light guide plate and is movable with respect to the chassis in the direction orthogonal to the thickness direction of the light guide plate, a heat dissipating member to which the light source unit is attached dissipating heat generated during driving of the light sources, and a bias unit biasing the light source unit to a direction approaching the incident face of the light guide plate.

### BACKGROUND

The present disclosure relates to a technical field of a display device. In detail, the present disclosure relates to a technical field for improving use efficiency of light emitted from a light source by biasing a light source unit to a direction close to an incident face of a light guide plate.

Display devices of television receivers, personal computers, or the like use, for example, a liquid crystal panel as a display for displaying images. Such a display is disposed inside a housing constituted by a plurality of chassis.

Since a liquid crystal panel is not a self-luminous display, such a display device described above is configured to radiate light as backlight from the back side face thereof to the liquid crystal panel. Thus, in a display device such as a liquid crystal display, or the like, which does not include a self-luminous display, a light source unit having a light source functioning as backlight radiating light from the back side face is disposed in the display.

As a light source of the light source unit, for example, light emitting diodes (LEDs) are used.

In regard to a display device having a light source functioning as backlight, there is a device type called a side-edge in which light sources are disposed in the sides of a light guide plate disposed on the back side face of a display, and light emitted from the light source is guided by the light guide plate to a predetermined direction so as to be radiated toward the display (for example, refer to Japanese Unexamined Patent Application Publication No. 2010-60862). In addition, in regard to such a display device having a light source functioning as backlight, there is also a device type called direct-down in which a light source is disposed on the back side face of the display, and light emitted from the light source is radiated toward the display.

The side-edge type display device has light sources disposed in the sides of a light guide plate, and thus a thin display device can be attained.

In the side-edge type display device, each light source is disposed on the outer circumference face (incident face) of the light guide plate facing each other from the sides thereof. Since the light sources and the drive boards thereof emit heat when the light sources are driven (emit light), the light source unit is configured to be disposed in a state of being attached to a heat dissipating member such as a heat spreader, or the like, so that the heat generated from the light source unit is transmitted to the chassis constituting the housing through the heat dissipating member, for example, to the back chassis and discharged to the outside.

The heat dissipating member is attached to the chassis by fastening screws, or the like, and the light guide plate is positioned to the chassis by caulking pins, or the like.

In the display device configured as described above, particularly the light guide plate expands in the direction orthogonal to the thickness direction thereof due to a temperature rise inside the housing, a temperature rise in the environment thereof, moisture absorption, or the like, caused by heat generated during driving of the light source.

If the light guide plate expands, the light sources disposed in the sides of the light guide plate come into contact with the light guide plate, and accordingly, there is concern that there will be damage to the light sources, driving disorder, or the like of the light sources, or breakage of the light guide plate due to heat of the light sources. For that reason, a predetermined space is formed between the side face (incident face) of the light guide plate and a light source considering expansion of the light guide plate in advance. In addition, when an impact is made from the outside of the display device, the space is necessary in order to prevent breakage of the light sources that is caused by contact of the light sources with the side faces of the light guide plate.

### SUMMARY

However, since a predetermined space is formed between the light sources and the incident face of the light guide plate considering the expansion of the light guide plate, or the like as described above, there are problems in that the distance between the incident face of the light guide plate and the light sources is considerable, incidence efficiency of light emitted from the light sources to the incident face is low, and light use efficiency is low.

Therefore, it is desirable for the display device of the present disclosure to solve the above-described problems and it is intended to improve the use efficiency of light emitted from the light sources, and the like.

According to an embodiment of the present disclosure, there is provided a display device which includes a housing that is constituted by at least one chassis, a display that is disposed inside the housing, a light guide plate that is disposed in the back side face of the display and of which at least one portion of the outer circumference face is formed as an incident face to which light is incident, a light source unit that has light sources that are disposed in the sides of the light guide plate so as to face the incident face of the light guide plate and is movable with respect to the chassis in the direction orthogonal to the thickness direction of the light guide plate, a heat dissipating member to which the light source unit is attached dissipating heat generated during driving of the light sources, and a bias unit that biases the light source unit to a direction approaching the incident face of the light guide plate.

Accordingly, in the display device, even when the light guide plate expands or contracts, the distance between the incident face of the light guide plate and the light sources is uniformly maintained.

In the above-described display device, the light source unit may be attached to the heat dissipating member, and the heat dissipating member may be biased with the light source unit.

The heat dissipating member and the light source unit are integrated at all times by attaching the light source unit to the heat dissipating member and biasing the heat dissipating member with the light source unit.

In the above-described display device, a stopper that abuts the incident face of the light guide plate and maintains the distance between the light incident face and the light sources so as to be uniform may be provided.

The incident face of the light guide plate and the light sources are in a non-contact state by providing stoppers that abuts the incident face of the light guide plate and maintains the distance between the light incident face and the light sources so as to be uniform.

In the above-described display device, a spacer may be disposed between the light source unit and the incident face of the light guide plate so as to be used as the stopper.

The spacer abuts the incident face of the light guide plate and maintains the distance between the incident face of the light guide plate and the light source by being disposed between the light source unit and the incident face of the light guide plate so as to be used as the stopper.

In the above-described display device, the stopper may be formed as one body with the heat dissipating member.

A stopper as a separate component from the heat dissipating member is made unnecessary by forming the stopper as one body with the heat dissipating member.

In the above-described display device, a coil spring that is used as the bias unit may be attached to the chassis.

The light source unit is biased to a direction approaching the incident face of the light guide plate by the coil spring by attaching the coil spring that is used as a bias unit to the chassis.

In the above-described display device, a cushion that is used as the bias unit may be disposed in the chassis.

The light source unit is biased to a direction approaching the incident face of the light guide plate by the cushion by disposing the cushion that is used as a bias unit to the chassis.

In the above-described display device, a plate spring portion that is formed by cutting up part of the chassis and used as the bias unit may be provided.

The light source unit is biased to a direction approaching the incident face of the light guide plate by the plate spring portion by providing the plate spring portion that is formed by cutting up part of the chassis and used as the bias unit.

In the above-described display device, a disposition notch may be formed in the heat dissipating member, and the bias unit may be disposed in the disposition notch.

The bias unit is not disposed outside the heat dissipating member by forming the disposition notch in the heat dissipating member and disposing the bias unit in the disposition notch.

In the above-described display device, a fitting projection portion that projects in the thickness direction of the light guide plate may be provided in the chassis, the fitting projection portion may be positioned in the disposition notch, and the bias unit may be fitted to the fitting projection portion.

The bias unit is fitted to the fitting projection portion in the disposition notch by providing the fitting projection portion that projects in the thickness direction of the light guide plate in the chassis, positioning the fitting projection portion in the disposition notch, and fitting the bias unit to the fitting projection portion.

In the above-described display device, a pressing member that regulates a rise of the light guide plate from the chassis in the thickness direction may be attached to the heat dissipating member.

The pressing member attached to the heat dissipating member presses the light guide plate in the chassis side by attaching the pressing member that regulates a rise of the light guide plate from the chassis in the thickness direction to the heat dissipating member.

In the above-described display device, a reflection face that reflects light emitted from the light sources and causes the light to be incident to the light guide plate may be formed in part of the pressing member.

Light that is emitted from the light sources and incident to the reflection face is reflected on the reflection face and incident to the light guide plate by forming the reflection face that reflects light emitted from the light sources and causes the light to be incident to the light guide plate in the part of the pressing member.

In the above-described display device, the outer circumference portion of the light guide plate may be set to be pressed by the pressing member.

The pressing member attached to the heat dissipating member presses the outer circumference portion of the light guide plate to the chassis side, by setting the pressing member to press the outer circumference portion of the light guide plate.

In the above-described display device, the heat dissipating member and the pressing member may be formed as one body.

The pressing member as a separate component from the heat dissipating member is made unnecessary by forming the heat dissipating member and the pressing member as one body.

The display device of the present disclosure includes a housing that is constituted by at least one chassis, a display that is disposed inside the housing, a light guide plate that is disposed in the back side face of the display and of which at least one portion of the outer circumference face is formed as an incident face to which light is incident, a light source unit that has light sources that are disposed in the sides of the light guide plate so as to face the incident face of the light guide plate and is movable with respect to the chassis in the direction orthogonal to the thickness direction of the light guide plate, a heat dissipating member to which the light source unit is attached dissipating heat generated during driving of the light sources, and a bias unit that biases the light source unit to a direction approaching the incident face of the light guide plate.

Accordingly, since the distance between the light sources and the incident face can get close and the amount of light incident to the light guide plate from the light sources increases, it is possible to improve use efficiency of light emitted from the light sources.

According to the technique described in the embodiment, the light source unit is attached to the heat dissipating member, and the heat dissipating member is biased with the light source unit.

Accordingly, heat generated in the light source unit is transmitted to the heat dissipating member at all times, and therefore, it is possible to secure a satisfactory heat dissipating property with a simple configuration.

According to the technique described in the embodiment, a stopper that abuts the incident face of the light guide plate and maintains the distance between the light incident face and the light sources so as to be uniform is provided.

Accordingly, the stopper forms a fixed space between the light sources and the incident face of the light guide plate, and therefore, it is possible to prevent the light guide plate from melting while high use efficiency of light is secured.

According to the technique described in the embodiment, a spacer that is used as the stopper is disposed between the light source unit and the incident face of the light guide plate.

Accordingly, it is possible to attain a simple configuration of the stopper and to simply set a space with a desired size between the light sources and the incident face of the light guide plate.

According to the technique described in the embodiment, the stopper is formed as one body with the heat dissipating member.

Accordingly, it is possible to achieve a reduction in the number of components.

According to the technique described in the embodiment, a coil spring that is used as the bias unit is attached to the chassis.

Accordingly, since the coil spring has a simple configuration, it is possible to attain the improvement of use efficiency of light emitted from the light sources without causing a complex configuration.

According to the technique described in the embodiment, a cushion that is used as the bias unit is disposed in the chassis.

Accordingly, since the bias unit has a simple configuration, it is possible to attain the improvement of use efficiency of light emitted from the light sources without causing a complex configuration.

According to the technique described in the embodiment, a plate spring portion that is formed by cutting up part of the chassis and used as the bias unit is provided.

Accordingly, it is possible to achieve a simple configuration and the reduced number of components of the bias unit.

According to the technique described in the embodiment, a disposition notch is formed in the heat dissipating member, and the bias unit is disposed in the disposition notch.

Accordingly, since the bias unit is disposed outside the heat dissipating member, it is possible to effectively use the disposition space of the bias unit and accordingly, to attain miniaturization of the display device.

According to the technique described in the embodiment, a fitting projection portion that projects in the thickness direction of the light guide plate is provided in the chassis, the fitting projection portion is positioned in the disposition notch, and the bias unit is fitted to the fitting projection portion.

Accordingly, it is possible to make the attachment of the bias unit easy, to achieve improvement of space efficiency, and to simply perform the attachment work of the bias unit.

According to the technique described in the embodiment, a pressing member that regulates the rise of the light guide plate from the chassis in the thickness direction is attached to the heat dissipating member.

Accordingly, it is possible to prevent the rise of the light guide plate from the back chassis, and therefore, to secure high use efficiency of light.

According to the technique described in the embodiment, a reflection face that reflects light emitted from the light sources and causes the light to be incident to the light guide plate is formed in part of the pressing member.

Accordingly, it is possible to achieve the improvement of use efficiency of light emitted from the light sources without increasing the number of components.

According to the technique described in the embodiment, the outer circumference portion of the light guide plate is set to be pressed by the pressing member.

Accordingly, it is possible to reliably prevent the rise of the light guide plate from the back chassis.

According to the technique described in the embodiment, the heat dissipating member and the pressing member are formed as one body.

Accordingly, it is possible to attain a reduction in the manufacturing cost of the display device resulting from the reduction in the number of components.

### BRIEF DESCRIPTION OF THE DRAWINGS

FIG. 1 is a perspective view showing a display device;

FIG. 2 is a perspective view showing the display device as viewed from the opposite side to FIG. 1;

FIG. 3 is a cross-sectional view of the display device;

FIG. 4 is an enlarged perspective view showing each part of a heat dissipating member, a light source unit, and a light guide plate;

FIG. 5 is an enlarged cross-sectional view showing positions of the light source unit, and the like when the light guide plate expands and contracts;

FIG. 6 is an enlarged perspective view showing a bias unit according to a first modified example;

FIG. 7 is an enlarged perspective view showing a bias unit according to a second modified example;

FIG. 8 is an enlarged perspective view showing a bias unit according to a third modified example;

FIG. 9 is an enlarged perspective view showing a bias unit according to a fourth modified example;

FIG. 10 is an enlarged perspective view showing another example of the bias unit according to the fourth modified example;

FIG. 11 is an enlarged perspective view showing still another example of the bias unit according to the fourth modified example;

FIG. 12 is an enlarged cross-sectional view showing a fifth modified example; and

FIG. 13 is an enlarged cross-sectional view showing a state in which a pressing member is attached to the heat dissipating member, and the light guide plate is pressed by the pressing member.

### DETAILED DESCRIPTION OF EMBODIMENTS

Hereinafter, exemplary embodiments for implementing a display device of the present disclosure will be described according to the accompanying drawings.

In the exemplary embodiments to be described below, the display device of the present disclosure is in application of a television receiver displaying image of the liquid crystal panel thereof.

Furthermore, the scope of applying the present disclosure is not limited to a television receiver with a liquid crystal panel, but can be broadly applied to various kinds of display devices such as monitors used in other various television receivers, personal computers, and the like, provided with a non-self-luminous display that has a light guide plate and a light source functioning as backlight.

### [Configuration of Display Device]

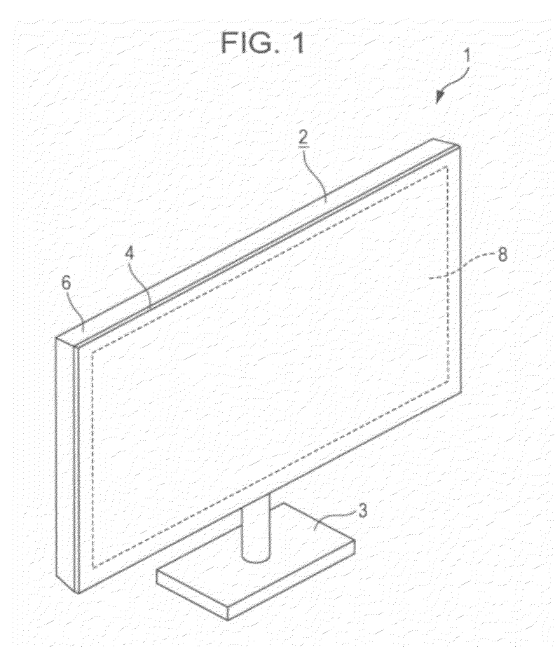

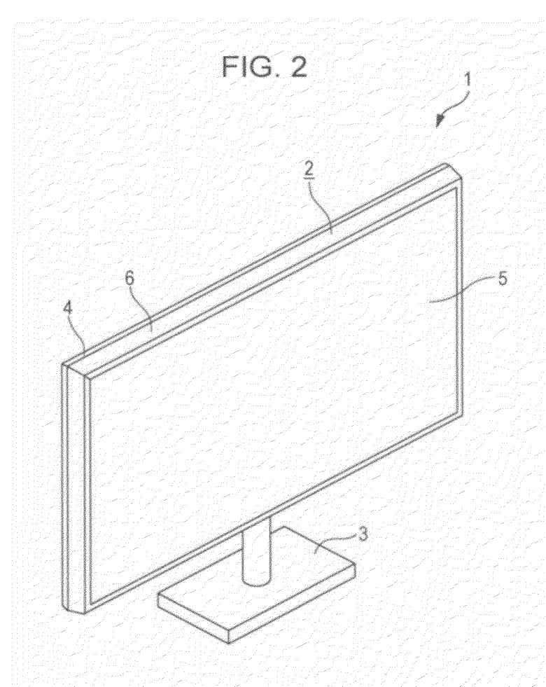

A display device (television receiver) 1 includes a housing 2 and each part disposed inside the housing 2 (refer to FIGS. 1 and 2). The internal space of the housing 2 is formed as an inner space 2a.

The display device 1 is provided with a stand 3 in order to be placed on a placement surface on, for example, a desk, or the like.

The housing 2 is formed in a flat shape in the front and back sides, and includes, as shown in FIGS. 1 to 3, a front chassis 4, a back chassis 5 positioned in the back side of the front chassis 4, and a frame chassis 6 positioned between the front chassis 4 and the back chassis 5.

The front chassis 4 is formed of transparent glass or a resin in a flat-plate shape.

The back chassis 5 is formed of a metal material having a high heat dissipating property in a plate shape, positioned in a state of being opposed to the front chassis 4, and combined with the back face of the frame chassis 6. The back chassis 5 may be formed with a plurality of heat dissipating holes.

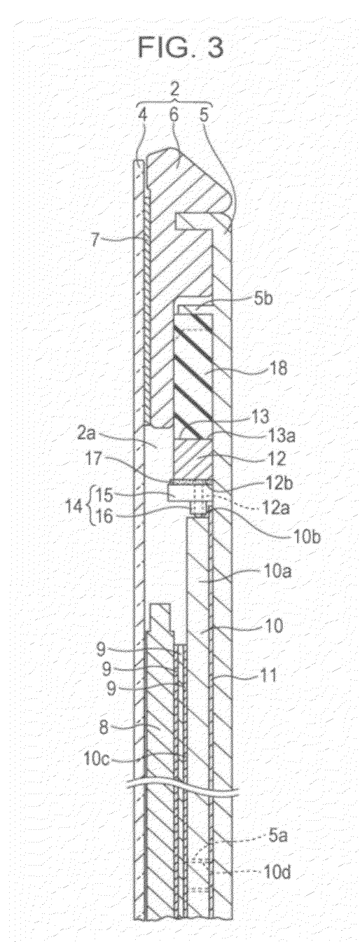

There are a plurality of fitting bosses 5a, 5a, . . . provided in the back chassis 5 projecting to the front side thereof (refer to FIG. 3). Standing wall portions 5b and 5b are provided at positions closer to the upper end and lower end of the back chassis 5 respectively extending to the lateral direction, and the standing wall portions 5b and 5b project to the front side.

The frame chassis 6 is formed in a rectangular shape, and the external shape has substantially the same dimension as that of the front chassis 4. The frame chassis 6 is formed of a resin or a metal material.

A frame-like or strip-like spacer sheet 7 is disposed between the front chassis 4 and the frame chassis 6, and the front chassis 4 and the frame chassis 6 are combined in a state of interposing the spacer sheet 7 therebetween. The spacer sheet is, for example, adhesive, and the front chassis 4 and the frame chassis 6 are fixed to each other via the spacer sheet.

A display (liquid crystal panel) 8 which displays image is disposed inside the housing 2. The display 8 is configured in such a way that, for example, a transmission type color liquid crystal panel is inserted between two polarization plates in the front and back sides, and displays full-color images by being driven in an active matrix scheme.

The display 8 is disposed inside the housing 2 in a state in which the front face abuts the back face of the front chassis 4. The external shape of the display 8 has a smaller dimension than that of the front chassis 4. In the back side of the display 8, a plurality of optical sheets 9, 9, and 9, a light guide plate 10, and a reflection sheet 11 are disposed from the front side in order in a state of abutting one another.

The optical sheets 9, 9, and 9 have a function, for example of dispersing light emitted from the light guide plate 10. It is necessary for the optical sheets 9, 9, and 9 to have a sufficient dispersing property and low light absorptivity in order to resolve the directivity of light emitted from the light guide plate 10.

The light guide plate 10 is formed of, for example, a transparent material such as acryl, or the like, in a plate shape having the external shape slightly larger than that of the display 8, and an outer circumference portion 10a is disposed so as to be positioned outside the outer circumference face of the display 8. In the outer circumference face orthogonal to the light guide plate 10, the upper face and the low face are respectively formed as incident faces 10b and 10b to which light is incident. The front face of the light guide plate 10 is formed as an emission face 10c from which light is emitted.

In the edge portion of the outer circumference side of the light guide plate 10, a plurality of mounting holes, or mounting notches 10d, 10d, . . . penetrating the plate to the front-back side, and the mounting holes 10d, 10d, . . . are positioned, for example, in the center portion in the longitudinal direction of the light guide plate 10 and the center portion in the lateral direction. The light guide plate 10 is fitted to the back chassis 5 in such a way that the fitting bosses 5a, 5a, . . . are respective inserted into the mounting holes 10d, 10d, . . . .

The reflection sheet 11 has a function of reflecting light that is incident to the light guide plate 10 and emitted from the back face of the light guide plate 10 and then leading the light to the emission face 10c.

Heat dissipating members 12 and 12 are disposed in the upper edge side and the lower edge side in the internal space of the housing 2 respectively extending in the lateral direction.

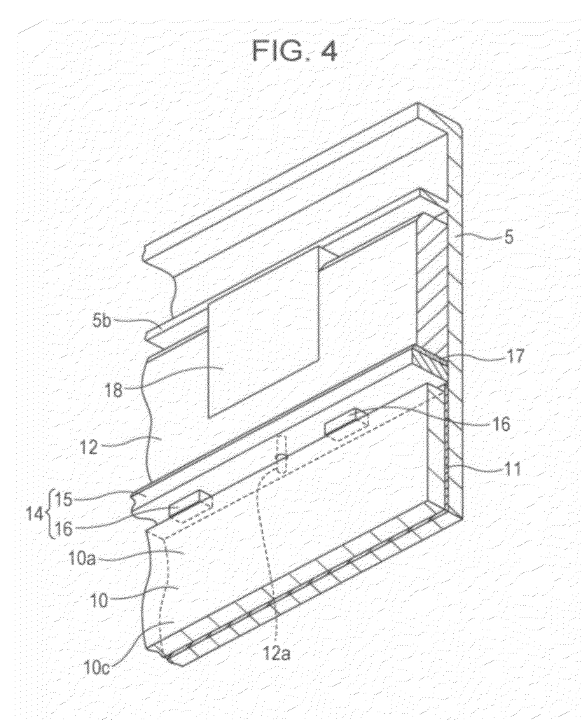

The heat dissipating member 12 is formed in a plate shape facing the forward-backward direction and extending in the lateral direction (refer to FIGS. 3 and 4). In the heat dissipating member 12, disposition notches 13, 13, . . . which are open to the outer side thereof (upper side or the lower side) having intervals laterally. In faces forming the disposition notches 13, 13, . . . , faces facing the upper side or the lower side are respective formed as press-pushed faces 13a, 13a, . . . .

In the heat dissipating members 12 and 12, stoppers 12a, 12a, . . . respectively projecting to the inner side (the lower side or the upper side) are formed, for example, as one body, and the stoppers 12a, 12a, . . . are laterally positioned with intervals.

The heat dissipating members 12 and 12 are in a state of being brought into contact with each of the frame chassis 6 and the back chassis 5 in the forward and backward direction, or a state having a fine space, and the heat dissipating members 12 and 12 can be moved in the upper-lower direction with respect to the back chassis 5.

An inner face (the upper face or the lower face) of the heat dissipating members 12 and 12 is formed as mounting faces 12b and 12b, and light source units 14 and 14 are attached to each of the mounting faces 12b and 12b.

The light source unit 14 includes a drive board 15 extending in the lateral direction and a plurality of light sources 16, 16, . . . , mounted on the drive board 15 and the light sources 16, 16, . . . are positioned in the lateral direction with an interval. As the light sources 16, 16, . . . , light emitting diodes (LEDs) are used. The light sources 16, 16, . . . , are positioned opposed to the incident face 10b of the light guide plate 10, and the distance between both is set to be, for example, 0.2 mm to 0.3 mm.

The drive boards 15 and 15 of the light units 14 and 14 are fixed to the heat dissipating members 12 and 12 using, for example, adhesives 17 and 17 double-sided tapes, or fitting screws.

Insertion holes that penetrate the drive boards 15 and 15 in the front-back side and are not shown in the drawings are formed in the lateral direction with an interval, and stoppers 12a, 12a, . . . , provided in the heat dissipating members 12 and 12 are inserted in the insertion holes. The edge faces of the stoppers 12a, 12a, . . . , are positioned slightly closer to the incident faces 10b and 10b of the light guide plate 10 than the edge faces of the light sources 16, 16, . . . , are. The edge faces of the stoppers 12a, 12a, . . . , abut the incident faces 10b and 10b of the light guide plate 10. The stoppers 12a, 12a, . . . , have a function of forming a fixed gap between the light sources 16, 16, . . . , and the incident faces 10b and 10b of the light guide plate 10.

Furthermore, there is a case shown above in which the stoppers 12a, 12a, . . . , are provided in the heat dissipating members 12 and 12, but the stoppers may not be provided in the heat dissipating members, but may be provide in other members only if the stoppers have the function of forming a fixed gap between the light sources 16, 16, . . . , and the incident faces 10b and 10b of the light guide plate 10. For example, stoppers may be provided projecting from the drive boards 15 and 15 in the upper-lower direction, or may be provided projecting from the light guide plate 10 in the upper-lower direction.

In addition, a spacer formed of a sheet, a resin, or the like can be disposed between the drive boards 15 and 15 and the incident faces 10b and 10b of the light guide plate 10 so that the spacer is used as a stopper.

Since the light sources 14 and 14 are fixed to each of the heat dissipating members 12 and 12, the light sources are moved according to the movements of the heat dissipating members 12 and 12 that are set to be movable in the upper-lower direction for the back chassis 5.

In the disposition notches 13, 13, . . . of the heat dissipating members 12 and 12, cushions 18, 18, . . . are disposed respectively functioning as bias units.

The cushion 18 can be elastically deformed, and formed of, for example, a rubber material, or the like, in a rectangular shape. The cushion 18 is disposed in the disposition notch 13 in a state in which respective faces thereof facing in the upper and lower directions are brought into contact with the standing wall portion 5b and the press-pushed face 13a.

Accordingly, the heat dissipating members 12 and 12 and the light source units 14 and 14 are biased by the cushion 18 in a direction approaching the incident faces 10b and 10b of the light guide plate 10. At this moment, the tips of the stoppers 12a, 12a, . . . , provided in the heat dissipating members 12 and 12 abut the incident faces 10b and 10b, forming a fixed gap between the light sources 16, 16, . . . , and the incident faces 10b and 10b.

### [Optical Path of Display Device]

In the display device 1 configured as above, if light is emitted from the light sources 16, 16, . . . , of the light source units 14 and 14, the emitted light is incident from the incident faces 10b and 10b to the light guide plate 10, guided to the upper-lower direction inside the light guide plate 10, and reflected on the inner face of the light guide plate 10. The light reflected on the inner face transmits through an emission face 10c of the light guide plate 10, radiated on the display 8 as backlight via optical sheets 9, 9, and 9, and emitted from the display 8 as video light.

At this moment, light that is incident to the light guide plate 10 and reflected by a reflection sheet 11 also transmits through the emission face 10c of the light guide plate 10, radiated on the display 8 as backlight via the optical sheets 9, 9, and 9, and emitted from the display 8 as video light.

### [Operation During Driving of Light Source]

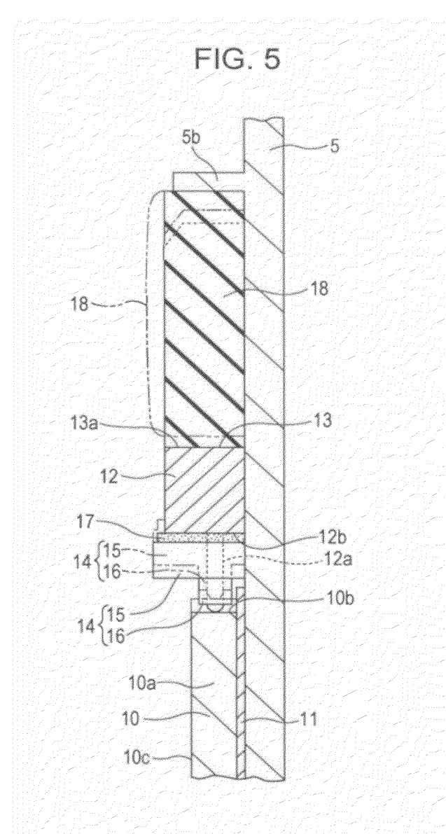

As described above, when the light sources 16, 16, . . . , emit light, the light source units 14 and 14 generate heat. When the light source units 14 and 14 generate heat, temperature of the inner space 2a, the chassis, the light guide plate, and optical sheets rises, and particularly, the light guide plate 10 expands in the direction orthogonal to the thickness direction, whereby the length thereof is lengthened in the lateral and longitudinal directions. At that moment, since the heat dissipating members 12 and 12 is set to be movable with respect to the back chassis 5 attached to the light guide plate 10, the heat dissipating members, as one body with the light source units 14 and 14, are moved in the longitudinal direction with respect to the back chassis 5 according to changes in the length of the light guide plate 10 in the longitudinal direction (refer to FIG. 5). Therefore, the distance between the light sources 16, 16, . . . , and the incident faces 10b and 10b of the light guide plate 10 is uniformly maintained.

In addition, when the light sources 16, 16, . . . stop emitting light, heat generation of the light source units 14 and 14 also stops, and accordingly, the temperature of the inner space 2a, the chassis, the light guide plate, and the optical sheets, which had been rising, drops, the light guide plate 10 contracts to the direction orthogonal to the thickness direction, whereby the length thereof in the lateral and the longitudinal directions is shortened. At that time also, the heat dissipating members 12 and 12, as one body with the light source units 14 and 14, are moved in the longitudinal direction with respect to the back chassis 5 according to changes in the length of the light guide plate 10 in the longitudinal direction. Therefore, the distance between the light sources 16, 16, . . . , and the incident faces 10b and 10b of the light guide plate 10 is uniformly maintained.

### Modified Examples

Hereinbelow, modified examples of the bias unit will be described. In the above description, an example has been shown in which the cushion 18 is used as a bias unit for biasing the heat dissipating members 12 and 12 and the light source units 14 and 14 to the side of the incident faces 10b and 10b of the light guide plate 10, however, a bias unit as below can also be used instead of the cushion 18.

### First Modified Example

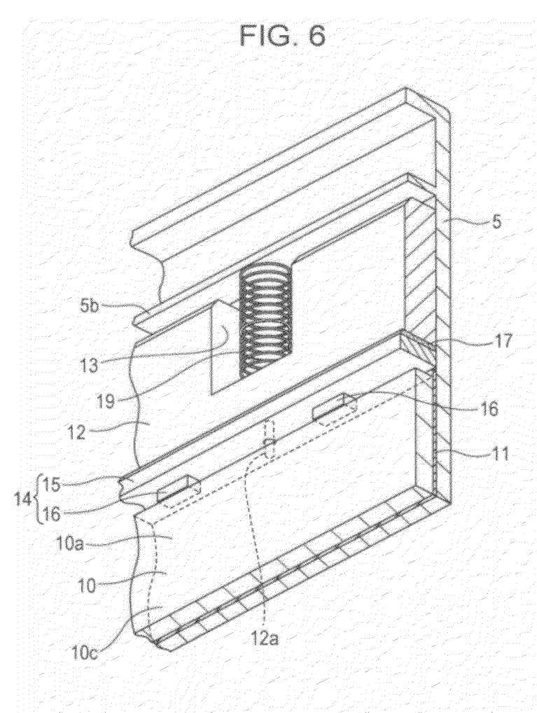

As a bias unit according to a first modified example, a compression coil spring 19 can be used (refer to FIG. 6).

The compression coil spring 19 is disposed between the stand wall portion 5b of the back chassis 5 and the press-pushed 13a in the disposition notch 13 of the heat dissipating member 12.

### Second Modified Example

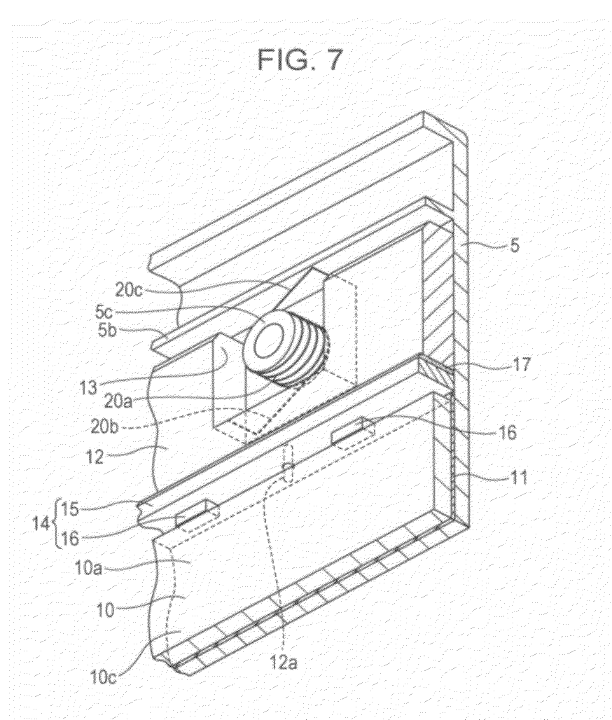

As a bias unit according to a second modified example, a torsion coil spring 20 can be used (refer to FIG. 7).

A fitting projection portion 5c which projects to the front side and is positioned in the disposition notch 13 formed in the heat dissipating member 12 is provided in the back chassis 5, a coil portion 20a of the torsion coil spring 20 is supported by the fitting projection portion 5c, one edge of the torsion coil spring comes into tight contact with the press-pushed face 13a of the heat dissipating member 12, and the other edge thereof comes into tight contact with the stand wall portion 5b of the back chassis 5.

### Third Modified Example

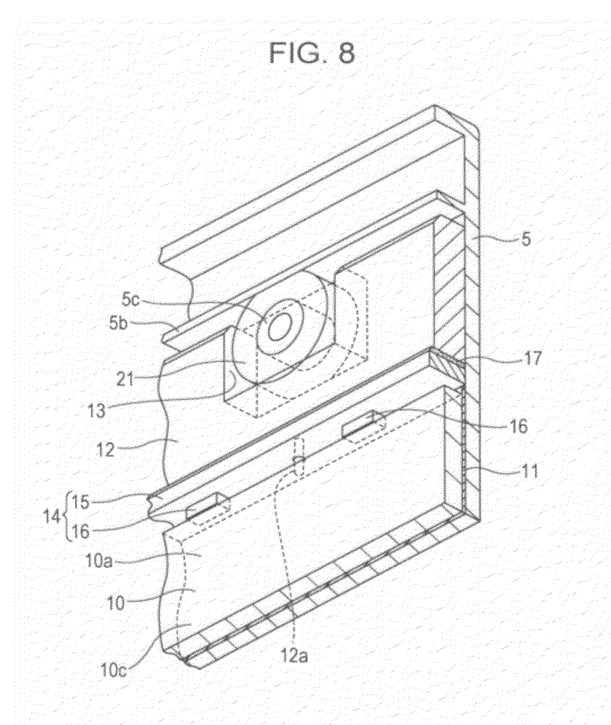

As a bias unit according to a third modified example, an annular cushion 21 can be used (refer to FIG. 8).

The fitting projection portion 5c which projects to the front side and is positioned in the disposition notch 13 formed in the heat dissipating member 12 is provided in the back chassis 5, and the cushion 21 is fitted to the fitting projecting portion 5c in such a way that the fitting projecting portion 5c is inserted into the center hole of the cushion 21 with pressure. The outer circumference face of the cushion 21 comes into tight contact with the press-pushed face 13a of the heat dissipating member 12.

### Fourth Modified Example

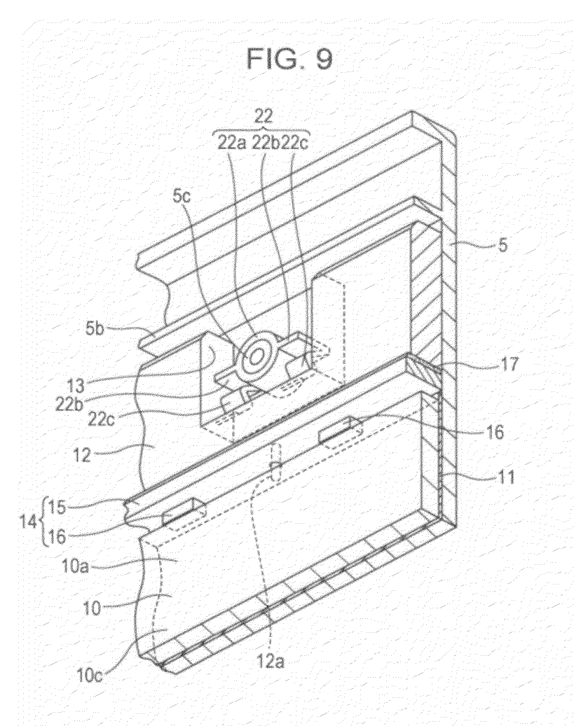

As a bias unit according to a fourth modified example a spring member 22 that is formed of, for example, a resin material can be used (refer to FIG. 9). The spring member 22 includes an annular fitted portion 22a, base portions 22b and 22b that project from the fitted portion 22a to the left and right sides, and spring portions 22c and 22c that project from the base portions 22b and 22b to the inner side (lower or upper side). The spring portions 22c and 22c are formed in wave shapes curved forward and backward in turn.

The fitting projection portion 5c which projects to the front side and is positioned in the disposition notch 13 formed in the heat dissipating member 12 is provided in the back chassis 5, and the spring member 22 is fitted to the fitting projection portion 5c in such a way that the fitting projection portion 5c is inserted into the press-pushed portion 22a of the spring member 22 with pressure. The edges of the spring portions 22c and 22c of the spring member 22 come into tight contact with the press-pushed face 13a of the heat dissipating member 12.

Furthermore, in the above description, an example has been shown in which the fitting projection portion 5c of the back chassis 5 is positioned in the disposition notch 13 formed in the heat dissipating member 12, however, it may be possible that a disposition hole penetrating the heat dissipating member 12 front and back is formed, and the fitting projection portion 5c is positioned in the disposition hole.

The spring member may have a shape, for example, as follows.

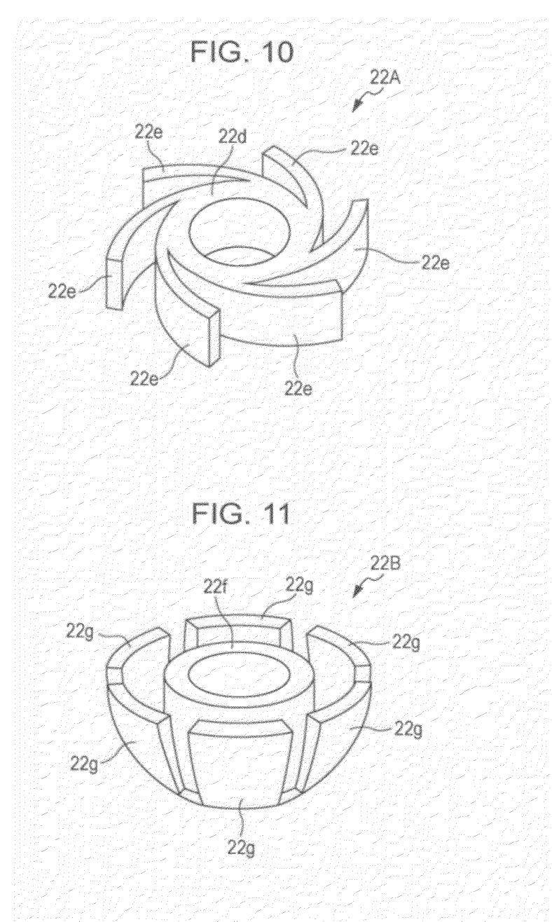

The spring member 22A includes, as shown in FIG. 10, an annular fitted portion 22d and spring portions 22e, 22e, . . . that project from separate positions on the outer circumference face of the fitted portion 22d in the circumference direction. The spring portions 22e, 22e, . . . are respectively formed in arc surfaced shapes having a curvature smaller than that of the fitted portion 22d, and one end in the arc direction continues to the fitted portion 22d.

The spring member 22A is fitted to the back chassis 5 in such a way that the fitting projection portion 5c is inserted into the attached portion 22d with pressure. Parts of the spring portions 22e, 22e, . . . of the spring member 22A come into tight contact with the press-pushed face 13a of the heat dissipating member 12.

A spring member 22B includes, as shown in FIG. 11, an annular fitted portion 22f and spring portions 22g, 22g, . . . that project from one edge of the fitted portion 22f in the axis direction. The spring portions 22g, 22g, . . . are positioned around the fitted portion 22f in the outer face side, and provided with arrangement having an equal interval in the circumferential direction. The spring portions 22g, 22g, . . . are set to have increasing gaps between the fitted portion 22f as the spring portions advances from one edge to the other edge in the axis direction of the fitted portion 22f.

The spring member 22B is fitted to the back chassis 5 in such a way that the fitting projection portion 5c is inserted into the fitted portion 22f with pressure. Some of the spring portions 22g, 22g, . . . of the spring member 22B comes into tight contact with the press-pushed face 13a of the heat dissipating member 12.

As described above, by using the spring members 22A and 22B having a plurality of spring portions 22e, 22e, . . . and spring portions 22g, 22g, . . . in the circumferential direction as a bias unit, it is possible to the spring members are fitted to the fitting projection portion 5c without considering the direction of the spring members 22A and 22B in the circumferential direction. Therefore, workability during fitting work can improve.

### Fifth Modified Example

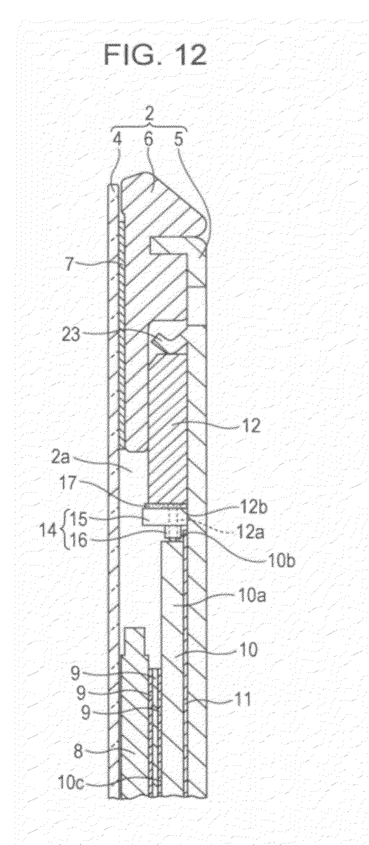

As a bias unit according to a fifth modified example, a plate spring portion 23 formed by cutting up part of the back chassis 5 can be used (refer to FIG. 12). Part of the plate spring portion 23 comes into tight contact with the press-pushed face 13a of the heat dissipating member 12.

By providing the plate spring portion 23 used as a bias unit formed by cutting up the part of the back chassis 5, it is possible to attain simplification of the configuration of the bias unit and reduction in the number of components.

### [Overview]

As described above, in the display device 1, the light source units 14 and 14 are biased to the incident faces 10b and 10b of the light guide plate 10, and the heat dissipating members 12 and 12 and the light source units 14 and 14 are movable with respect to the back chassis 5.

Therefore, the distance between the light sources 16, 16, . . . and the incident faces 10b and 10b of the light guide plate 10 is uniformly maintained in the state in which the light guide plate 10 expands or contracts, the distance between the light sources 16, 16, . . . and the incident faces 10b and 10b gets closer accordingly, and therefore, the amount of light incident from the light sources 16, 16, . . . to the light guide plate 10 increases.

As such, since the amount of light incident from the light sources 16, 16, . . . to the light guide plate 10 increases, it is possible to achieve use efficiency of light emitted from the light sources 16, 16, . . . .

In addition, since the distance between the light sources 16, 16, . . . and the incident faces 10b and 10b of the light guide plate 10 does not change regardless of the expansion and contraction of the light guide plate 10, deformation such as warpage of each member, or the like, errors made during the manufacture of components including the chassis, the light guide plate, and the like, there is no change in the amount of light incident from the light sources 16, 16, . . . to the light guide plate 10, and it is possible to suppress unevenness in luminous of light emitted from the display 8.

In addition, since it is possible to achieve improvement of use efficiency of light emitted from the light sources 16, 16, . . . , it is possible to reduce the number of light sources 16, 16, . . . or reduce the amount of light according to the extent, and the number of components can be reduced and manufacturing cost can be cut.

Furthermore, since use efficiency of light improves by increasing the amount of light incident from the light sources 16, 16, . . . to the light guide plate 10, it is possible to make the thickness of the light guide plate 10 thin, and accordingly, the display device 1 can be made thin.

Furthermore, if the light sources 16, 16, . . . comes into contact with the incident faces 10b and 10b of the light guide plate 10, there is concern that the light guide plate 10 melts by heat generated during driving of the light sources 16, 16, . . . , and therefore, it is desirable to form a slight space between the light sources 16, 16, . . . and the incident faces 10b and 10b.

Thus, a prescribed space is formed between the light sources 16, 16, . . . and the incident faces 10b and 10b of the light guide plate 10 by stoppers 12a, 12a, . . . provided in the heat dissipating members 12, 12, . . . , the stoppers provided in the drive boards 15 and 15, and stoppers or spacers provided in the light guide plate 10, as described above. Therefore, it is possible to prevent melting of the light guide plate 10 maintaining high use efficiency of light.

In addition, by forming a prescribed space between the light sources 16, 16, . . . and the incident faces 10b and 10b of the light guide plate 10 by stoppers 12a, 12a, . . . , the stoppers provided in the drive boards 15 and 15, and stoppers or spacers provided in the light guide plate 10, it is possible to prevent damage on the light sources 16, 16, . . . without contact of the light sources 16, 16, . . . and the incident faces 10b and 10b even when an impact is made to the display device 1 from the outside.

Furthermore, by forming the stoppers 12a, 12a, . . . with the heat dissipating members 12 and 12 as one body, it is possible to attain a reduction in the number of components. Furthermore, it is also possible to attain a reduction in the number of components by forming the stoppers provided in the drive board 15 and 15 and the stoppers provided in the light guide plate 10 with each of the drive boards 15 and 15 and the light guide plate 10 as one body.

Furthermore, by using the spacers as stoppers, it is possible to achieve simplification of the configuration of the stoppers, and to easily set the space between the light sources 16, 16, . . . and the incident faces 10b and 10b of the light guide plate 10 to a desirable dimension.

In addition, since the light source units 14 and 14 are attached to the heat dissipating members 12 and 12, and the heat dissipating members 12 and 12 is biased together with the light source units 14 and 14 by the bias unit, heat generated in the light source units 14 and 14 is transmitted to the heat dissipating members 12 and 12, and it is possible to secure a satisfactory heat dissipating property in a simple configuration.

Furthermore, as described above, since the bias unit has a simple configuration by providing the cushion 18 or the cushion 21 in the as a bias unit for the back chassis 5, it is possible to achieve improvement of use efficiency of light emitted from the light sources 16, 16, . . . without causing complexity of the configuration.

In addition, as described in the first and the second modified examples, by attaching the compression coil spring 19 and the torsion coil spring 20 to the back chassis 5 as bias units, the compression coil spring 19 and the torsion coil spring 20 have simple configurations, and therefore, it is possible to achieve improvement of use efficiency of light emitted from the light sources 16, 16, . . . without causing complexity of the configuration.

Furthermore, by disposing the disposition notch 13 in the heat dissipating member 12 and disposing the bias unit in the disposition notch 13, the bias unit is not disposed in the outside of the heat dissipating member 12, and therefore, it is possible to effectively use the disposition space of the bias unit and accordingly to attain miniaturization of the display device 1.

By positioning the fitting projection portion 5c in the disposition hole or the disposition notch 13 formed in the heat dissipating member 12, and attaching the bias member to the fitting projection portion 5c, attaching the bias unit is simple, and it is possible to easily work the attachment of the bias unit with improved space efficiency.

### [Miscellaneous]

In the display device 1, the heat dissipating members 12 and 12 are biased to a direction approaching each of the incident faces 10b and 10b of the light guide plate 10, and by an angle of the stoppers 12a, 12a, . . . coming into contact with the incident faces 10b and 10b of the light guide plate 10, for example, there is concern that the light guide plate 10 rises to the front side from the back chassis 5. In addition, there is concern that warpage of the light guide plate 10 occurs due to heat generated during driving of the light sources 16, 16, . . . , and the light guide plate 10 rises to the front side from the back chassis 5.

If the rise of the light guide plate 10 occurs as above, the amount of light incident from the incident faces 10b and 10b decreases, or the direction of light emission from the emission face 10c changes, and therefore, use efficiency of light drops.

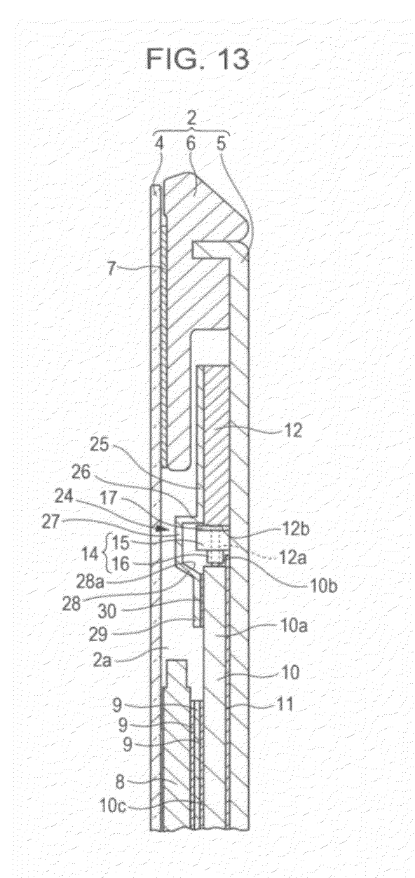

Thus, as described below, it is desirable to provide a pressing member for regulating the rise of the light guide plate 10 from the back chassis 5 (refer to FIG. 13).

The pressing members 24 and 24 are attached to the heat dissipating members 12 and 12.

The pressing member 24 includes a base portion 25 that is positioned in the outermost side thereof, a first connection portion 26 that projects forward from the edge of the inner side of the base portion 25, a second connection portion 27 that projects inward from the front edge of the first connection portion 26, an inclination portion 28 that projects so as to be inclined backward from the edge of the inner side of the second connection portion 27 as it goes inner side, and a pressing portion 29 that projects to the inner side from the edge of the inner side of the inclination portion 28. The inner face of the inclination portion 28 is formed as a reflection face 28a.

The pressing member 24 is attached to the front face of the heat dissipating member 12 in such a way that the base portion 25 is attached thereto by, for example, a double-sided tape 30, an adhesive, an attachment screw, or the like.

The light guide plate 10 is configured such that the outer circumference portion 10a thereof is pressed from the front side by the pressing portion 29 of the pressing member 24. Since the pressing member 24 is attached to the heat dissipating member 12, the heat dissipating member 12 and the light source unit 14 are formed as one body and moves in longitudinal direction with respect to the back chassis 5 according to changes in the length in the longitudinal direction as the light guide plate 10 expands or contracts.

As described above, by attaching the pressing member 24 that regulates a rise of the heat dissipating member 12 from the back chassis 5 in the front direction (thickness direction) of the light guide plate 10, the rise of the light guide plate 10 from the back chassis 5 is prevented and therefore, high use efficiency of light can be secured.

In addition, by pressing the outer circumference portion 10a of the light guide plate 10 with the pressing portion 29 of the pressing member 24, it is possible to reliably prevent the rise of the light guide plate 10 from the back chassis 5.

In the above description, an example has been shown in which the pressing member 24 is separately formed from the heat dissipating member 12, but for example, the pressing member 24 can also be formed as one body with the heat dissipating member 12 as a part thereof.

It is possible to achieve a drop in the manufacturing cost of the display device 1 from a reduction in the number of components by forming the pressing member 24 as one body with the heat dissipating member 12 as a part thereof.

Furthermore, when light is emitted from the light sources 16, 16, . . . , there is light that is not incident to the incident faces 10b and 10b due to the emission angle of light, but light incident to the reflection faces 28a and 28a of the pressing members 24 and 24 from the light that is not incident to the incident faces 10b and 10b is reflected on the reflection faces 28a and 28a. The light that is reflected on the reflection faces 28a and 28a is incident to the inside of the light guide plate 10, and guided to the longitudinal direction inside of the light guide plate 10.

As such, by forming the reflection faces 28a and 28a that reflect light emitted from the light sources 16, 16, . . . in the pressing members 24 and 24 and cause the light to be incident to the light guide plate 10, it is possible to achieve improvement of use efficiency of the light emitted from the light sources 16, 16, . . . without increasing the number of components.

In the above description, an example has been shown in which the heat dissipating members 12 and 12 and the light source units 14 and 14 are disposed respective portions of both upper and lower edges in the inner space 2a of the housing 2, but the disposition location of the heat dissipating members 12 and 12 is not limited to both lower and upper edges in the inner space 2a, but may be either portion of the upper edge or the lower edge in the inner space 2a.

In addition, the disposition location of the heat dissipating members 12 and 12 is not limited to both lower and upper edges in the inner space 2a, but may be both right and left edges, either of the right edge or the left edge, or four upper, lower, right and left edges.

Furthermore, in the description, an example has been shown in which LEDs are used as the light sources 16, 16, . . . , but may be other kind including fluorescent light, or the like, as the light sources 16, 16, . . . .

### [Present Technology]

The present technology can also have configurations as follows.

(1) A display device including a housing that is constituted by at least one chassis, a display that is disposed inside the housing, a light guide plate that is disposed in the back side face of the display and of which at least one portion of the outer circumference face is formed as an incident face to which light is incident, a light source unit that has light sources that are disposed in the sides of the light guide plate so as to face the incident face of the light guide plate and is movable with respect to the chassis in the direction orthogonal to the thickness direction of the light guide plate, a heat dissipating member to which the light source unit is attached dissipating heat generated during driving of the light sources, and a bias unit that biases the light source unit to a direction approaching the incident face of the light guide plate.

(2) The display device described (1) above in which the light source unit is attached to the heat dissipating member, and the heat dissipating member is biased with the light source unit.

(3) The display device described in (1) or (2) above in which a stopper that abuts the incident face of the light guide plate and maintains the distance between the light incident face and the light sources so as to be uniform is provided.

(4) The display device described in any one of (1) to (3) above, in which a spacer that is used as the stopper is disposed between the light source unit and the incident face of the light guide plate.

(5) The display device described in (3) above in which the stopper is formed as one body with the heat dissipating member.

(6) The display device described in any one of (1) to (5) in which a coil spring that is used as the bias unit is attached to the chassis.

(7) The display device described in any one of (1) to (5) in which a cushion that is used as the bias unit is disposed in the chassis.

(8) The display device described in any one of (1) to (5) in which a plate spring portion that is formed by cutting up part of the chassis and used as the bias unit is provided.

(9) The display device described in any one of (1) to (8) in which a disposition notch is formed in the heat dissipating member, and the bias unit is disposed in the disposition notch.

(10) The display device described in (9) above in which a fitting projection portion that projects in the thickness direction of the light guide plate is provided in the chassis, the fitting projection portion is positioned in the disposition notch, and the bias unit is fitted to the fitting projection portion.

(11) The display device described in any one of (1) to (10) above in which a pressing member that regulates a rise of the light guide plate from the chassis in the thickness direction is attached to the heat dissipating member.

(12) The display device described in (11) above in which a reflection face that reflects light emitted from the light sources and causes the light to be incident to the light guide plate is formed in part of the pressing member.

(13) The display device described in (11) or (12) above in which the outer circumference portion of the light guide plate is set to be pressed by the pressing member.

(14) The display device described in any one of (11) to (13) above in which the heat dissipating member and the pressing member are formed as one body.

Specific shapes and configurations of each of the part shown in the exemplary embodiments for implementing the present disclosure described above are just examples for realizing the present disclosure, and the technical scope of the present disclosure is not supposed to be interpreted such as to be limited by the examples.

The present disclosure contains subject matter related to that disclosed in Japanese Priority Patent Application JP 2011-076569 filed in the Japan Patent Office on Mar. 30, 2011, the entire contents of which are hereby incorporated by reference.

What is claimed is:

1. A display device comprising:
a housing that is constituted by at least one chassis;
a display that is disposed inside the housing;
a light guide plate that is disposed in the back side face of the display and of which at least one portion of the outer circumference face is formed as an incident face to which light is incident;
a light source unit that has light sources that are disposed in the sides of the light guide plate so as to face the incident face of the light guide plate and is movable with respect to the chassis in the direction orthogonal to the thickness direction of the light guide plate;
a heat dissipating member to which the light source unit is attached dissipating heat generated during driving of the light sources; and
a bias unit that biases the light source unit to a direction approaching the incident face of the light guide plate.

2. The display device according to claim 1,
wherein the light source unit is attached to the heat dissipating member, and
the heat dissipating member is biased with the light source unit.

3. The display device according to claim 1,
wherein a stopper that abuts the incident face of the light guide plate and maintains the distance between the light incident face and the light sources so as to be uniform is provided.

4. The display device according to claim 3,
wherein a spacer that is used as the stopper is disposed between the light source unit and the incident face of the light guide plate.

5. The display device according to claim 3,
wherein the stopper is formed as one body with the heat dissipating member.

6. The display device according to claim 1,
wherein a coil spring that is used as the bias unit is attached to the chassis.

7. The display device according to claim 1,
wherein a cushion that is used as the bias unit is disposed in the chassis.

8. The display device according to claim 1,
wherein a plate spring portion that is formed by cutting up part of the chassis and used as the bias unit is provided.

9. The display device according to claim 1,
wherein a disposition notch is formed in the heat dissipating member, and
the bias unit is disposed in the disposition notch.

10. The display device according to claim 9,
wherein a fitting projection portion that projects in the thickness direction of the light guide plate is provided in the chassis,
the fitting projection portion is positioned in the disposition notch, and
the bias unit is fitted to the fitting projection portion.

11. The display device according to claim 1,
wherein a pressing member that regulates a rise of the light guide plate from the chassis in the thickness direction is attached to the heat dissipating member.

12. The display device according to claim 11,
wherein a reflection face that reflects light emitted from the light sources and causes the light to be incident to the light guide plate is formed in part of the pressing member.

13. The display device according to claim 11,
wherein the outer circumference portion of the light guide plate is set to be pressed by the pressing member.

14. The display device according to claim 11,
wherein the heat dissipating member and the pressing member are formed as one body.
